(19) United States
(12) Patent Application Publication
(10) Pub. No.: US 2021/0374982 A1
(43) Pub. Date: Dec. 2, 2021

(54) Systems and Methods for Illuminating Physical Space with Shadows of Virtual Objects

(71) Applicant: Disney Enterprises, Inc., Burbank, CA (US)

(72) Inventors: Zdravko V. Velinov, Burbank, CA (US); Kenneth John Mitchell, Earlston (GB); Joseph G. Hager, IV, Valencia, CA (US)

(21) Appl. No.: 16/885,172

(22) Filed: May 27, 2020

(51) Int. Cl. G06T 7/507; G06T 11/00; G06T 7/80

(52) U.S. Cl. CPC G06T 7/507; G06T 7/80; G06T 11/00

(57) ABSTRACT

A system can be used in conjunction with a display configured to display an augmented reality (AR) environment including a virtual object placed in a real environment, the virtual object having a virtual location in the AR environment. The system includes a projector, a memory storing a software code, and a hardware processor configured to execute the software code to: determine a projector location of the projector in the real environment; generate a shadow projection in the real environment, the shadow projection corresponding to the virtual object and being based on the virtual location of the virtual object and the projector location; and project, using the projector, a light pattern in the real environment, the light pattern including a light projection and the shadow projection corresponding to the virtual object.

### BACKGROUND

Augmented reality (AR) environments merge virtual objects or characters with real objects in a way that can, in principle, provide an immersive interactive experience to a user. AR environments can augment a real environment, i.e., a user can see the real environment through a display or lens with virtual objects overlaid or projected thereon. A wide range of devices and image compositing technologies aim to bring virtual objects into the real world. Mobile, stationary, and head-mounted displays (HMDs) and projectors were previously used to display virtual objects with real objects. However, to sustain the illusion in the user's mind that virtual objects are indeed present, virtual objects should appear to affect lighting in the real environment much as if they were real objects.

Conventional approaches to generating AR environments rely on additive compositing which fails to account for illumination masking phenomena, such as shadows and filtering caused by opaque and partially opaque virtual objects that affect the real world lighting. Conventional approaches also suffer from lighting mismatch between virtual shadows and the real environment when displayed as part of the AR environment. Typically, the AR environment needs to be significantly brighter than the real environment to produce the illusion of shadows in relative sense.

In a related aspect, projectors can be employed to composite effects onto real objects in the real environment. Certain configurations similarly have difficulties representing shadows. Occluding real objects can prevent correctly compositing effects onto real objects behind them. Multiple projectors are thus required to fill in gaps in the projection.

### SUMMARY

There are provided systems and methods for illuminating physical space with shadows of virtual objects substantially as shown in and/or described in connection with at least one of the figures, and as set forth more completely in the claims.

### BRIEF DESCRIPTION OF THE DRAWINGS

FIG. 1 shows a diagram of an exemplary system configured to generate a shadow projection corresponding to a virtual object, according to one implementation;

FIG. 2 shows an exemplary perspective view of a calibration pattern projected in a real environment by the system of FIG. 1, according to one implementation;

FIG. 3 shows an exemplary perspective view of a shadow projection corresponding to a virtual object, the shadow projection being generated by the system of FIG. 1 in a real environment, according to one implementation;

FIG. 4A shows an exemplary perspective view of a shadow projection corresponding to a virtual object, an occluded portion, and a virtual shadow, the shadow projection and the occluded portion being generated in a real environment and the virtual shadow being generated in a virtual environment by the system of FIG. 1, according to one implementation;

FIG. 4B shows an exemplary perspective view of a shadow projection corresponding to a virtual object, an illuminated portion, and a virtual shadow, the shadow projection and the illuminated portion being generated in a real environment and the virtual shadow being generated in a virtual environment by the system of FIG. 1, according to one implementation;

FIG. 5A shows a flowchart presenting an exemplary method of using the system of FIG. 1 for generating a shadow projection corresponding to a virtual object, according to one implementation; and

FIG. 5B shows a flowchart presenting an exemplary method of using the system of FIG. 1 for generating an occluded portion, an illuminated portion, and a virtual shadow, according to one implementation.

### DETAILED DESCRIPTION

The following description contains specific information pertaining to implementations in the present disclosure. One skilled in the art will recognize that the present disclosure may be implemented in a manner different from that specifically discussed herein. The drawings in the present application and their accompanying detailed description are directed to merely exemplary implementations. Unless noted otherwise, like or corresponding elements among the figures may be indicated by like or corresponding reference numerals. Moreover, the drawings and illustrations in the present application are generally not to scale, and are not intended to correspond to actual relative dimensions.

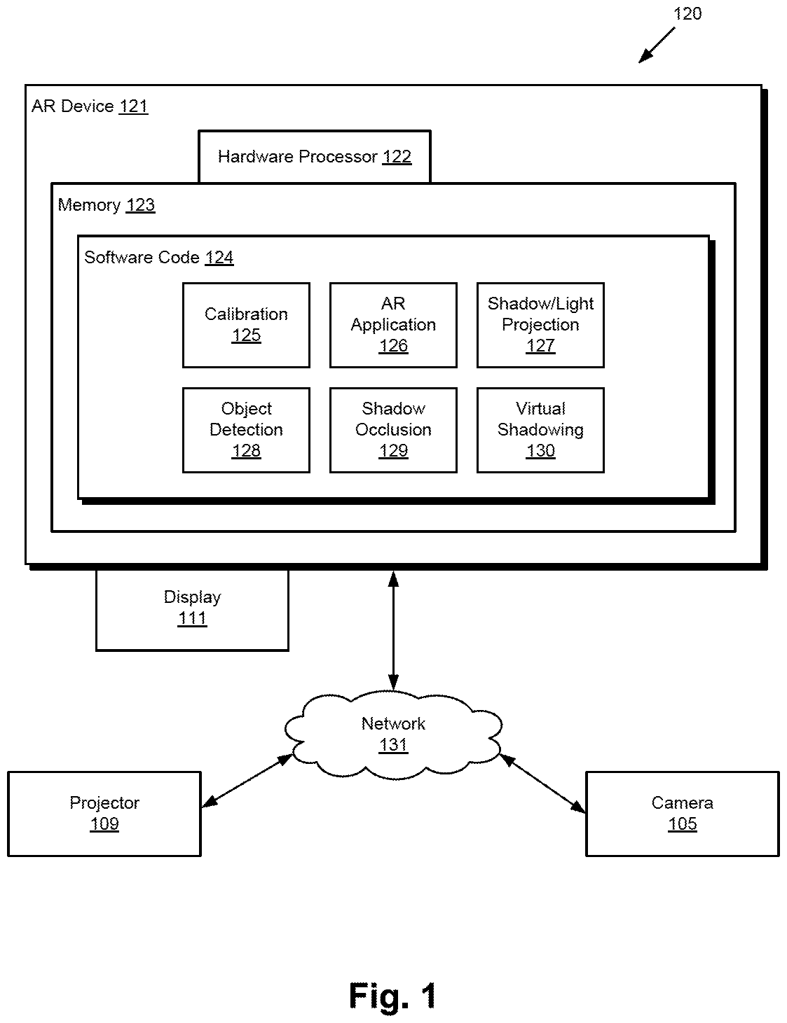

FIG. 1 shows a diagram of an exemplary system configured to generate a shadow projection corresponding to a virtual object, according to one implementation. As shown in FIG. 1, exemplary system 120 includes augmented reality (AR) device 121 having hardware processor 122 and memory 123 implemented as a non-transitory storage device software code 124. Software code 124 includes modules for calibration, AR application 126, shadow/light projection 127, object detection 128, shadow occlusion 129, and virtual shadowing 130. In addition, system 120 includes camera 105, projector 109, display 111, and network 131.

Hardware processor 122 of AR device 121 is configured to execute software code 124 to determine a projector location of projector 109 in a real environment. Hardware processor 122 may also be configured to execute software code 124 to generate a shadow projection corresponding to a virtual object, and being based on a virtual location of the virtual object and the determined projector location. Hardware processor 122 may be further configured to execute software code 124 to project, using projector 109, a light pattern such as a spotlight in the real environment, the light pattern including a light projection and the shadow projection corresponding to the virtual object. The examples herein refer to projecting a spotlight pattern, however it is contemplated that other types of lighting such as flood lighting, omnidirectional lighting, and indirect lighting may be useful in particular applications with suitable modifications to equipment and shadow/light projection 127. Similarly, projector 109 can be augmented with specular or diffuse reflectors to provide indirect light although these techniques increase computational complexity and shadows from diffuse light sources produce a less dramatic effect. Optionally, hardware processor 122 may be further configured to execute software code 124 to display, on display 111, an AR environment including the virtual object placed in the real environment, with the spotlight, including the light projection and the shadow projection, as part of the real environment.

Hardware processor 122 may be the central processing unit (CPU) for AR device 121, for example, in which role hardware processor 122 runs the operating system for AR device 121 and executes software code 124. Hardware processor 122 may also be a graphics processing unit (GPU) or an application specific integrated circuit (ASIC). Memory 123 may take the form of any computer-readable non-transitory storage medium. The expression “computer-readable non-transitory storage medium,” as used in the present application, refers to any medium, excluding a carrier wave or other transitory signal that provides instructions to a hardware processor of a computing platform, such as hardware processor 122 of AR device 121. Thus, a computer-readable non-transitory medium may correspond to various types of media, such as volatile media and non-volatile media, for example. Volatile media may include dynamic memory, such as dynamic random access memory (dynamic RAM), while non-volatile memory may include optical, magnetic, or electrostatic storage devices. Common forms of computer-readable non-transitory media include, for example, RAM, programmable read-only memory (PROM), erasable PROM (EPROM), and FLASH memory.

It is noted that although FIG. 1 depicts software code 124 as being located in memory 123, that representation is merely provided as an aid to conceptual clarity. More generally, AR device 121 may include one or more computing platforms, such as computer servers for example, which may be co-located, or may form an interactively linked but distributed system, such as a cloud based system, for instance. As a result, hardware processor 122 and memory 123 may correspond to distributed processor and memory resources within system 120. Thus, software code 124 may be stored remotely within the distributed memory resources of system 120.

In various implementations, AR device 121 may be a smartphone, smartwatch, tablet computer, laptop computer, personal computer, smart TV, home entertainment system, or gaming console, to name a few examples. In one implementation, AR device 121 may be a head-mounted AR device. AR device 121 is shown to be integrated with display 111. AR application 126 may utilize display 111 to display an AR environment, and virtual shadowing 130 may utilize display 111 to display virtual shadows. In various implementations, AR device 121 may be integrated with camera 105 or projector 109. In other implementations, AR device 121 may be a standalone device communicatively coupled to camera 105, projector 109, and/or display 111.

Display 111 may be implemented as a liquid crystal display (LCD), a light-emitting diode (LED) display, an organic light-emitting diode (OLED) display, or any other suitable display screen that produces light in response to signals. In one implementation, display 111 is a head-mounted display (HMD). In various implementation, display 111 may be an opaque display or an optical see-through display. It is noted that although FIG. 1 depicts AR device 121 as including a single display 111, that representation is also merely provided as an aid to conceptual clarity. More generally, AR device 121 may include one or more displays, which may be co-located, or interactively linked but distributed. In various implementations, system 120 may include one or more speakers that play sounds for images shown on display 111.

According to the exemplary implementation shown in FIG. 1, camera 105, projector 109, and AR device 121 are communicatively coupled via network 131. Network 131 enables communication of data between camera 105, projector 109, and AR device 121. Network 131 may correspond to a packet-switched network such as the Internet, for example. Alternatively, network 131 may correspond to a wide area network (WAN), a local area network (LAN), or included in another type of private or limited distribution network. Network 131 may be a wireless network, a wired network, or a combination thereof. Camera 105, projector 109, and AR device 121 may each include a wireless or wired transceiver enabling transmission and reception of data.

Camera 105 captures light, such as images of a real environment and real objects therein created by light reflecting from real surfaces or emitted from light emission sources. Calibration 125, object detection 128, and/or other modules of software code 124 may utilize images captured by camera 105 and received over network 131, for example, to determine a projector location of projector 109 in the real environment or a real object location of a real object in the real environment. Camera 105 may be implemented by one or more still cameras, such as single shot cameras, and/or one or more video cameras configured to capture multiple video frames in sequence. Camera 105 may be a digital camera including a complementary metal-oxide-semiconductor (CMOS) or charged coupled device (CCD) image sensor or any device or combination of devices that captures imagery, depth information, and/or depth information derived from the imagery. Camera 105 may also be implemented by an infrared camera. In one implementation, camera 105 is a red-green-blue-depth (RGB-D) camera that augments conventional images with depth information, for example, on a per-pixel basis. It is noted that camera 105 may be implemented using multiple cameras, such as a camera array, rather than an individual camera.

Projector 109 may project light, for example, with a system of lenses. Shadow/light projection 127 may utilize projector 109 to project light projections and shadow projections in a real environment, and shadow occlusion 129 may utilize projector 109 to replace occluded portions of shadow projections with illuminated portions. In various implementations, projector 109 may be a digital light processing (DLP) projector, an LCD projector, or any other type of projector.

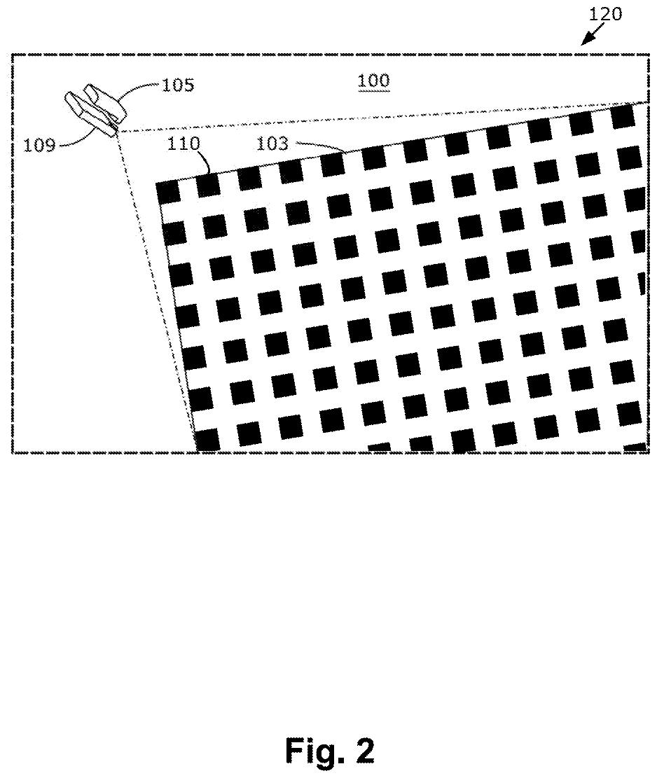

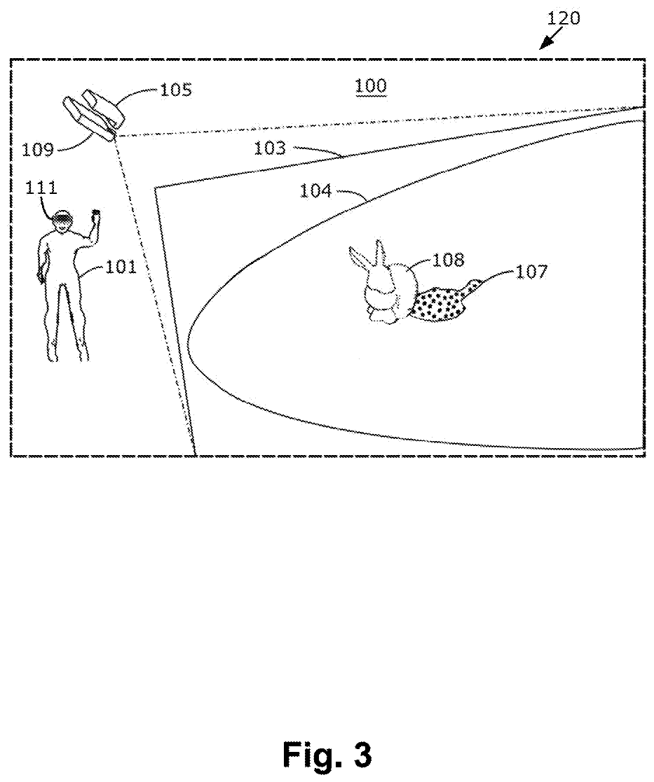

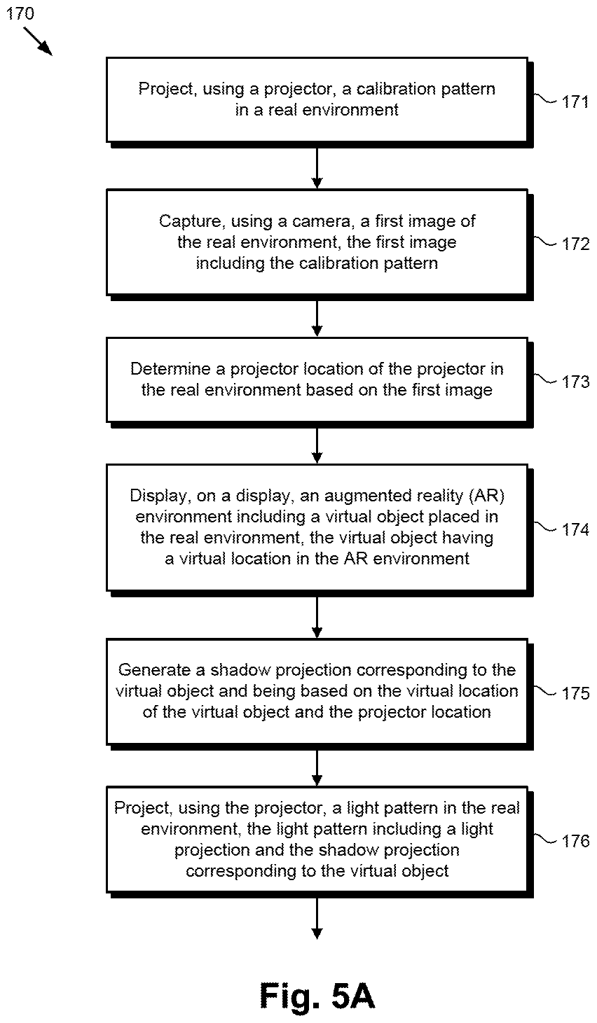

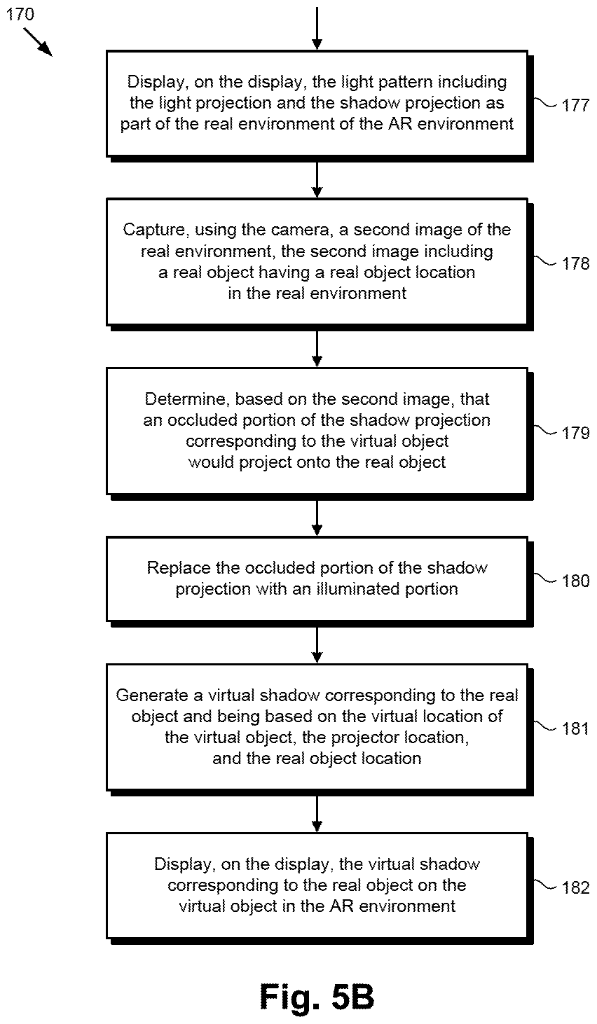

The functionality of system 120 will be further described by reference to FIG. 5A in combination with FIGS. 2 and 3. FIG. 5A shows flowchart 170 presenting an exemplary method of using system 120 of FIG. 1 for generating a shadow projection corresponding to a virtual object, according to one implementation. It is noted that certain details and features have been left out of flowchart 170 in order not to obscure the discussion of the inventive features in the present application.

Flowchart 170 begins at action 171 with projecting, using projector 109, calibration pattern 110 in real environment 100. FIG. 2 shows an exemplary perspective view of calibration pattern 110 projected in real environment 100 by system 120 of FIG. 1, according to one implementation. System 120, camera 105, and projector 109 in FIG. 2 correspond respectively in general to system 120, camera 105, and projector 109 in FIG. 1, and those corresponding features may share any of the characteristics attributed to either corresponding feature by the present disclosure. Thus, although not explicitly shown in FIG. 2, features of AR device 121 in FIG. 1, such as hardware processor 122, memory 123, and software code 124, may be implemented elsewhere in system 120 in FIG. 2, such as in projector 109 or in a standalone device in real environment 100.

As shown in FIG. 2, calibration pattern 110 may be real light projected by projector 109 in a set of shapes and outlines. In the present implementation, calibration pattern 110 uses small square shapes and a grid outline. In various implementations, any other shapes and size can be used. The shapes and outlines of calibration pattern 110 may be any color of light. For example, the shapes and outlines may be two different colors of light having high contrast. As another example, the shapes may be light while the outlines are shadow, or vice versa. Calibration pattern 110 may be predetermined by calibration 125 of software code 124 in FIG. 1. Calibration 125 may retrieve calibration pattern 110 from a calibration pattern database (not shown), for example, in memory 123 or over network 131. Calibration 125 may also instruct projector 109 to project calibration pattern 110.

Calibration pattern 110 may be substantially uniform as projected from projector 109. When calibration pattern 110 is projected in real environment 100, the shapes may skew and scale based on an angle and a proximity of projector 109 to objects in real environment 100. Calibration 125 of software code 124 may utilize this skew and scale to determine a projector location of projector 109 in real environment 100. Region 103 of real environment 100 occupied by calibration pattern 110 may substantially define boundaries of an interactive region of real environment 100 in which a virtual object may be placed or a light pattern may be projected. In the present implementation, region 103 of real environment 100 occupied by calibration pattern 110 spans a substantially flat region, such as a floor. In various implementations, calibration pattern 110 may be projected onto any other region of real environment 100, such as a non-planar region, one or more walls, and/or one or more other real objects.

Flowchart 170 continues at action 172 with capturing, using camera 105, a first image of real environment 100, the first image including calibration pattern 110. As shown in FIG. 2, camera 105 may be mounted in real environment 100 proximal to projector 109 and facing the same direction. Calibration 125 of software code 124 may instruct camera 105 to capture the first image of real environment 100 while projector 109 projects calibration pattern 110. In one implementation, camera 105 is integrated with projector 109. In various implementations, camera 105 and projector 109 need not be co-located. For example, camera 105 can be integrated with display 111 or located elsewhere in real environment 100. In one implementation, the first image is an RBG-D image including both color and depth information.

Flowchart 170 continues at action 173 with determining a projector location of projector 109 in real environment 100 based on the first image. Calibration 125 of software code 124 may perform action 173. For example, calibration 125 of software code 124 may receive the first image from camera 105 over network 131. Because the original calibration pattern 110 is predetermined, calibration 125 may utilize image processing algorithms to identify skewed and scaled shapes of calibration pattern 110 in the first image, as well as to identify the degree of skew and scale for each shape. Calibration 125 may then utilize this skew and scale in a set of geometric calculations to determine the projector location of projector 109 in real environment 100. Where the first image is an RGB-D image, calibration 125 may also utilize depth information to determine the projector location. The determined projector location can be defined in terms of any three-dimensional (3D) coordinate system, such as a Cartesian or polar coordinate system. As used herein, a “projector location” may refer to a position of projector 109 as well as an orientation of projector 109. The projector location may be stored, for example, in memory 123.

In one implementation, system 120 may utilize more than one camera 105 to improve the accuracy of the determined projector location. In one implementation, projector 109 may sequentially project calibration patterns, such as calibration pattern 110 scanned through different angles, while camera 105 captures images for each calibration pattern, and calibration 125 may determine the projector location based on the plurality of captured images. In one implementation, actions 171, 172, and 173 may be repeated periodically, in case projector 109 or real environment 100 moves, or real objects are removed from or added to real environment 100. In this implementation, camera 105 may be a video camera. In one implementation, calibration 125 of software code 124 may determine the projector location based on the first image without utilizing calibration pattern 110, for example, using advanced image processing algorithms without projecting a predetermined pattern. In various implementations, calibration 125 determines the projector location without a first image, for example, using ranging sensors or selecting among discrete predetermined projector locations. In one implementation, calibration 125 may also determine a location of region 103, or objects therein.

Flowchart 170 continues at action 174 with displaying, on display 111, an AR environment including virtual object 108 placed in real environment 100, with virtual object 108 having a virtual location in the AR environment. FIG. 3 shows an exemplary perspective view of shadow projection 107 corresponding to virtual object 108, with shadow projection 107 being generated by system 120 of FIG. 1 in real environment 100, according to one implementation. Display 111 in FIG. 3 corresponds respectively in general to display 111 in FIG. 1, and those corresponding features may share any of the characteristics attributed to either corresponding feature by the present disclosure. Thus, although not explicitly shown in FIG. 3, like display 111 in FIG. 1, display 111 in FIG. 3 may include an integrated AR device corresponding to integrated AR device 121 in FIG. 1.

Referring to FIG. 3, projector 109 no longer projects calibration pattern 110. Rather, virtual object 108 is placed in region 103 of real environment 100. AR application 126 of software code 124 in FIG. 1 may perform action 174. Virtual object 108 is shown with dotted lines in FIG. 3 to illustrate that virtual object 108 is not visible with the naked eye; virtual object 108 is displayed on display 111 as part of an AR environment.

In the present implementation, the AR environment displayed on display 111 includes real environment 100 plus virtual object 108. A camera (not shown) may be integrated with display 111, such that display 111 can display real environment 100 from approximately the point of view of user 101. Alternatively, display 111 can include a lens or glasses through which user 101 can see real environment 100. Virtual object 108 can then be displayed in real environment 100. For example, virtual object 108 may be displayed as an overlay over real environment 100. In the present implementation, virtual object 108 is a 3D rabbit. Virtual object 108 has a virtual location in the AR environment. The virtual location generally indicates where virtual object 108 is placed in relation to real environment 100. AR application 126 may utilize the virtual location to adjust the size, position, and orientation of virtual object on display 111 as user 101 moves about, such that virtual object 108 is displayed as if it were a real object.

Virtual object 108 may be rendered by AR application 126 of software code 124 in FIG. 1. AR application 126 may retrieve data describing virtual object 108 from a virtual object database (not shown), for example, in memory 123 or over network 131. AR application 126 may assign the virtual location to virtual object 108, store the virtual location in memory 123, animate virtual object 108, and alter the virtual location in response to animated movement of virtual object 108. AR application 126 may also instruct display 111 to display virtual object 108. Virtual object 108 may have any colors. In various implementations, display 111 may display virtual objects other than those shown in FIG. 3. In one implementation, virtual object 108 may be semi-transparent. In one implementation, virtual object 108 may be a two-dimensional (2D) virtual object.

Flowchart 170 continues at action 175 with generating shadow projection 107 in real environment 100, with shadow projection 107 corresponding to virtual object 108 and being based on the virtual location of virtual object 108 and the projector location of projector 109. As used herein, a shadow projection “corresponding to” a virtual object refers to the shadow projection having a location, shape, and appearance that approximately mimics a shadow that would be produced if the virtual object were a real object. Action 127 may be performed by shadow/light projection 127 of software code 124 in FIG. 1. For example, shadow/light projection 127 may model a light projection from projector 109 and may model virtual object 108. Shadow/light projection 127 may then utilize ray tracing simulations based on the projector location and the location, shape, and transparency/opacity of virtual object 108. Shadow/light projection 127 may then determine areas where virtual object 108 would cast a shadow in real environment 100 if virtual object 108 were a real object. Shadow/light projection 127 may then generate instructions for projector 109 to reduce or avoid illumination in those areas, thereby generating shadow projection 107.

Flowchart 170 continues at action 176 with projecting, using projector 109, a light pattern including light projection 104 and shadow projection 107 corresponding to virtual object 108. As shown in FIG. 3, the light pattern projected by projector 109 is a spotlight. The spotlight includes light projection 104 and shadow projection 107. Light projection 104 may be any colored light, such as white light, monochromatic color, polychromatic color, polarized and include non-visible light such as infrared and/or ultraviolet wavelengths. Shadow projection 107 may be an absence of light in the spotlight projected from projector 109. More generally, shadow projection 107 may be a reduction of intensity or change of color to simulate effects of a translucent virtual object 108. Also, shadow projection 107 may implement gradation of light intensity to simulate shadow penumbra. Light projection 104 creates contrast for and defines shadow projection 107. In other words, the spotlight may function as a digital gobo. In the present implementation, light projection 104 is projected from projector 109 as a substantially circular light pattern, minus a pattern corresponding to shadow projection 107. In various implementations, light projection 104 may have any other patterns, including static and moving patterns and patterns that change size and/or shape. Shadow projection 107 creates the absence of light in real environment 100 as if virtual object 108 were a real object illuminated by light projection 104. In one implementation, shadow/light projection 127 and projector 109 may alter the spotlight in response to animated movement of virtual object 108 such that shadow projection 107 appropriately tracks virtual object 108.

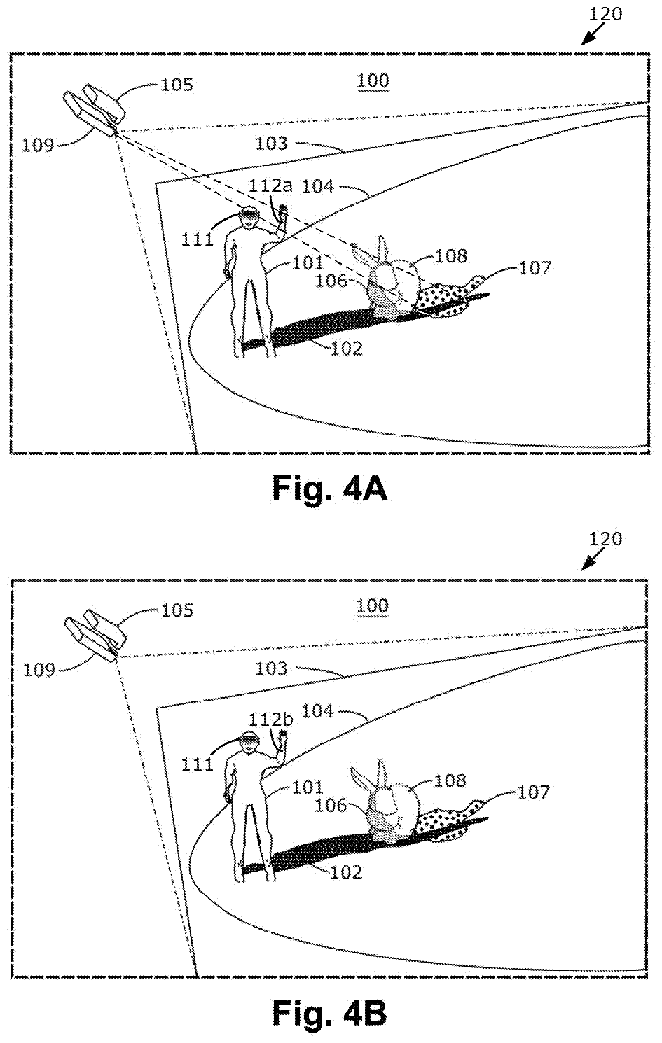

The functionality of system 120 will be further described by reference to FIG. 5B in combination with FIGS. 3, 4A, and 4B. FIG. 5B shows flowchart 170 presenting an exemplary method of using system 120 of FIG. 1 for generating an occluded portion, an illuminated portion, and a virtual shadow, according to one implementation. It is noted that certain details and features have been left out of flowchart 170 in order not to obscure the discussion of the inventive features in the present application.

Referring to FIG. 5B, flowchart 170 continues at action 177 with displaying, on display 111, the light pattern including light projection 104 and shadow projection 107 as part of real environment 100 of the AR environment. Notably, unlike virtual object 108, the light pattern including light projection 104 and shadow projection 107 exists in real environment 100 and is visible to the naked eye. As a result, the light pattern including light projection 104 and shadow projection 107 will be treated as part of real environment 100 by AR application 126 when generating the AR environment and displaying the AR environment on display 111. In particular, because shadow projection 107 is not artificial, shadow projection 107 does not suffer from any lighting mismatch with real environment 100 when displayed as part of the AR environment. Accordingly, system 120 provides a more immersive AR experience for user 101. System 120 is further advantageous in that it can provide an indication of where virtual object 108 might exist in the AR environment even when user 101 does not possess display 111, because user 101 may still observe shadow projection 107.

Flowchart 170 continues at action 178 with capturing, using camera 105, a second image of real environment 100, the second image including a real object having a real object location in real environment 100. FIG. 4A shows an exemplary perspective view of shadow projection 107 corresponding to virtual object 108, occluded portion 112a, and virtual shadow 106, with shadow projection 107 and occluded portion 112a being generated in real environment 100 and virtual shadow 106 being generated in a virtual environment by system 120 of FIG. 1, according to one implementation.

As shown in FIG. 4A, user 101 has changed its location and is now in region 103. User 101 is utilized in the present implementation as an example of a real object. However, as used herein, a “real object” may refer to any real object and not only a user of system 120. Similarly, a “real object location” may refer to the location of any real object and not only the location of a user of system 120.

Object detection 128 of software code 124 in FIG. 1 may instruct camera 105 to capture the second image of real environment 100 when user 101 is in region 103. For example, calibration 125 may instruct camera 105 to capture the second picture when a motion sensor (not shown) detects motion of a real object. As another example, calibration 125 may instruct camera 105 to capture the second picture when camera 105 moves, for example, using a motorized mount. As yet another example, object detection 128 may track previous real object locations of a real object using previously captured pictures, estimate the current real object location of the real object, and instruct camera 105 to capture the second picture when the estimated current real object location is within region 103 or a predetermined threshold thereof. In one implementation, camera 105 may capture the second image without instruction from object detection 128, for example, as a frame of a video camera. Except for differences noted above, the second image may be captured by camera 105 using any of the techniques described above with respect to action 172 and capturing the first image.

Flowchart 170 continues at action 179 with determining, based on the second image, that occluded portion 112a of shadow projection 107 corresponding to virtual object 108 would project onto the real object. As shown in FIG. 4A, user 101 creates occluded portion 112a in real environment 100. As used herein, an “occluded portion” refers to a portion of shadow projection 107 of a light pattern from projector 109 projecting onto a real object intervening between the projector location of projector 109 and an area where virtual object 108 would cast a shadow in real environment 100 if virtual object 108 were a real object. In the present implementation, occluded portion 112a is caused by user 101 in the path between projector 109 and the intended area of shadow projection 107. As user 101 enters region 103, a portion of user shadow 102 overlaps a portion shadow projection 107 of the light pattern. Occluded portion 112a corresponds to this overlap. Occluded portion 112a may create a less immersive VR experience for user 101 by drawing attention to the fact that the light pattern projected by projector 109 is not entirely light projection 104.

In one implementation, shadow occlusion 129 of software 124 in FIG. 1 determines occluded portion 112a based on depth information of the second image. For example, in the present information, shadow occlusion 129 may utilize depth information from the second image to determine that user 101 intervenes between the projector location of projector 109 and the intended area of shadow projection 107. In another implementation, shadow occlusion 129 determines occluded portion 112a by utilizing image processing to detect a shadow portion in the second image, and utilizing statistical similarities to determine whether the shadow portion corresponds to shadow projection 107 or to a shadow cast by an object obscuring light projection 104. Camera 105 and projector 109 may or may not be co-located. In various implementation, action 179 may include determining the real object location, including position and orientation, of user 101. In various implementations, shadow occlusion 129 and/or object detection 128 may predict that occluded portion 112a would project onto user 101 by tracking previous real object locations of user 101, for example using previously captured pictures and/or motion sensor information, estimating the current real object location of user 101, and determining that user 101 intervenes between the projector location of projector 109 and the intended area of shadow projection 107 based on the estimated current real object location.

Flowchart 170 continues at action 180 with replacing occluded portion 112a of shadow projection 107 with illuminated portion 112b. FIG. 4B shows an exemplary perspective view of shadow projection 107 corresponding to virtual object 108, illuminated portion 112b, and virtual shadow 106, with shadow projection 107 and illuminated portion 112b being generated in real environment 100 and virtual shadow 106 being generated in a virtual environment by system 120 of FIG. 1, according to one implementation.

As shown in FIG. 4B, although user 101 has not moved, projector 109 no longer creates occluded portion 112a in real environment 100. Rather, projector 109 projects illuminated portion 112b. Shadow occlusion 129 and/or shadow/light projection 127 may instruct projector 109 to project illuminated portion 112b. In the present implementation, illuminated portion 112b includes light projection 104. For example, both illuminated portion 112b and light projection 104 may be white light. In various implementations, illuminated portion 112b and light projection 104 may have different lighting. In implementations where system 120 predicts that occluded portion 112a would project onto a real object, shadow occlusion 129 and/or shadow/light projection 127 may begin rendering illuminated portion 112b prior to actual occlusion.

Although FIGS. 4A and 4B illustrate that illuminated portion 112b perfectly and completely replaces occluded portion 112a, it is noted that the present application does not require such perfect or complete replacement. In some implementations, it may be desirable to err in favor of illuminated portion 112b being smaller, to avoid illuminated portion 112b illuminating some of the intended area of shadow projection 107. In another implementation, illuminated portion 112b may have a gradient that is darker near its edges. For example, shadow occlusion 129 may apply an anti-aliasing algorithm to prevent staircase patterns appearing on illuminated portion 112b. The anti-aliasing can be achieved by averaging subpixels samples from the second image and/or subsequent images, by filtering them by a filter kernel based on the proximity to the filter center, by filtering them based on anisotropic Gaussian representation, or by accounting for distortion by applying a kernel predetermined by calibration 125. Anti-aliasing can be performed on luminance values or on each subpixel component color separately.

It is noted that actions 178, 179, and/or 180 in flowchart 170 may be performed prior to actions 174, 176, and/or 177. For example, illuminated portion 112b can replace occluded portion 112a of shadow projection 107 prior to projector 109 projecting a light pattern. As a result, system 120 may avoid ever projecting occluded portion 112a in real environment 100 or displaying occluded portion 112a in the AR environment. In turn, system 120 may avoid any latency associated with replacing occluded portion 112a after projecting or display it.

Flowchart 170 continues at action 180 with generating virtual shadow 106 corresponding to the real object and being based on the virtual location of virtual object 108, the projector location of projector 109, and the real object location of the real object. As shown in FIGS. 4A and 4B, user 101 creates user shadow 102 as user 101 enters region 103 and blocks a portion of light projection 104. Because user 101 is a real object, but virtual object 108 is not, user shadow 102 cannot be cast on virtual object 108. However, to provide a more immersive AR experience, it may be desirable for user shadow 102 to appear to be cast on virtual object 108 as if virtual object 108 were a real object.

Action 180 may be performed by virtual shadowing 130 of software code 124 in FIG. 1. For example, virtual shadowing 130 may model light projection 104 from projector 109, user 111, and virtual object 108. Virtual shadowing 130 may then utilize ray tracing simulations based on the projector location, the real object location of user 101, and the virtual location. Virtual shadowing 130 may then determine areas on virtual object 108 where user 101 would cast a shadow in real environment 100 if virtual object 108 were a real object. Virtual shadowing 130 may then generate instructions for AR application 126 to avoid illuminating corresponding areas on virtual object 108 in the AR environment. In a similar manner, virtual shadowing 130 may generate virtual shadows corresponding to virtual objects instead of or in addition to virtual shadows corresponding to real objects.

Flowchart 170 continues at action 182 with displaying, on display 111, virtual shadow 106 corresponding to the real object (e.g., user 101) on virtual object 108 in the AR environment. AR application 126 of software code 124 in FIG. 1 may perform action 182. It is noted that virtual shadow 106 in FIGS. 4A and 4B is not visible with the naked eye; virtual shadow 106 is displayed on display 111 as part of the AR environment. AR application 126 may adjust virtual shadow 106 on display 111 in response to user 101 moving about, and in response to animated movement of virtual object 108. In a similar manner, AR application 126 may display virtual shadows corresponding to virtual objects instead of or in addition to virtual shadows corresponding to real objects.

Thus, the present application discloses various implementations of systems for illuminating shadows in mixed reality as well as methods for use by such systems. Various techniques can be used for implementing the concepts described in the present application without departing from the scope of those concepts. Moreover, while the concepts have been described with specific reference to certain implementations, a person of ordinary skill in the art would recognize that changes can be made in form and detail without departing from the scope of those concepts. As such, the described implementations are to be considered in all respects as illustrative and not restrictive. The present application is not limited to the particular implementations described herein, but many rearrangements, modifications, and substitutions are possible without departing from the scope of the present disclosure.

What is claimed is:

1. A system comprising:
a projector;
a display;
a memory storing a software code;
a hardware processor configured to execute the software code to:
determine a projector location of the projector in a real environment;
display, on the display, an augmented reality (AR) environment including a virtual object placed in the real environment, the virtual object having a virtual location in the AR environment;
generate a shadow projection in the real environment, the shadow projection corresponding to the virtual object and being based on the virtual location of the virtual object and the projector location; and
project, using the projector, a light pattern in the real environment, the light pattern including a light projection and the shadow projection corresponding to the virtual object;
wherein displaying the AR environment further displays the light pattern including the light projection and the shadow projection as part of the real environment.

2. The system of claim 1, further comprising a camera, wherein the hardware processor is further configured to execute the software code to:
capture, using the camera, an image of the real environment; and
determine the projector location in relation to the real environment based on the image.

3. The system of claim 2, wherein the hardware processor is further configured to execute the software code to:
project, using the projector, a calibration pattern in the real environment, wherein the image includes the calibration pattern.

4. The system of claim 1, further comprising a camera, wherein the hardware processor is further configured to execute the software code to:
capture, using the camera, an image of the real environment, wherein the image includes a real object having a real object location in the real environment.

5. The system of claim 4, wherein the hardware processor is further configured to execute the software code to:
determine, based on the image, that an occluded portion of the shadow projection corresponding to the virtual object would project onto the real object; and
replace the occluded portion of the shadow projection with an illuminated portion.

6. The system of claim 5, wherein the illuminated portion includes the light projection of the light pattern.

7. The system of claim 5, wherein the occluded portion is determined based on depth information of the image.

8. The system of claim 7, wherein the camera comprises a red-green-blue-depth (RGB-D) camera.

9. The system of claim 4, wherein the hardware processor is further configured to execute the software code to:
generate a virtual shadow corresponding to the real object and being based on the virtual location of the virtual object, the projector location, and the real object location; and
display, on the display, the virtual shadow corresponding to the real object on the virtual object in the AR environment.

10. The system of claim 1, wherein the display comprises a head-mounted display (HMD).

11. A system for use in conjunction with a display configured to display an augmented reality (AR) environment including a virtual object placed in a real environment, the virtual object having a virtual location in the AR environment, the system comprising:
a projector;
a memory storing a software code;
a hardware processor configured to execute the software code to:
determine a projector location of the projector in the real environment;
generate a shadow projection in the real environment, the shadow projection corresponding to the virtual object and being based on the virtual location of the virtual object and the projector location; and
project, using the projector, a light pattern in the real environment, the light pattern including a light projection and the shadow projection corresponding to the virtual object.

12. The system of claim 11, further comprising a camera, wherein the hardware processor is further configured to execute the software code to:
capture, using the camera, an image of the real environment; and
determine the projector location in relation to the real environment based on the image.

13. The system of claim 12, wherein the hardware processor is further configured to execute the software code to:
project, using the projector, a calibration pattern in the real environment, wherein the image includes the calibration pattern.

14. The system of claim 11, further comprising a camera, wherein the hardware processor is further configured to execute the software code to:
capture, using the camera, an image of the real environment, wherein the image includes a real object having a real object location in the real environment;
determine, based on the image, that an occluded portion of the shadow projection corresponding to the virtual object would project onto the real object; and
replace the occluded portion of the shadow projection with an illuminated portion.

15. The system of claim 11, further comprising a camera, wherein the hardware processor is further configured to execute the software code to:
capture, using the camera, an image of the real environment, wherein the image includes a real object having a real object location in the real environment;
generate a virtual shadow corresponding to the real object and being based on the virtual location of the virtual object, the projector location, and the real object location; and
display, on the display, the virtual shadow corresponding to the real object on the virtual object in the AR environment.

16. A method for use in conjunction with a display displaying an augmented reality (AR) environment including a virtual object placed in a real environment, the virtual object having a virtual location in the AR environment, the method comprising:
determining a projector location of a projector in the real environment;
generating a shadow projection in the real environment, the shadow projection corresponding to the virtual object and being based on the virtual location of the virtual object and the projector location; and
projecting, using the projector, a light pattern in the real environment, the light pattern including a light projection and the shadow projection corresponding to the virtual object.

17. The method of claim 16, further comprising:
capturing, using a camera, an image of the real environment; and
determining the projector location in relation to the real environment based on the image.

18. The method of claim 17, further comprising:
projecting, using the projector, a calibration pattern in the real environment, wherein the image includes the calibration pattern.

19. The method of claim 16, further comprising:
capturing, using a camera, an image of the real environment, wherein the image includes a real object having a real object location in the real environment;
determining, based on the image, that an occluded portion of the shadow projection corresponding to the virtual object would project onto the real object; and
replacing the occluded portion of the shadow projection with an illuminated portion.

20. The method of claim 16, further comprising:
capturing, using a camera, an image of the real environment, wherein the image includes a real object having a real object location in the real environment;
generating a virtual shadow corresponding to the real object and being based on the virtual location of the virtual object, the projector location, and the real object location; and
displaying, on the display, the virtual shadow corresponding to the real object on the virtual object in the AR environment.
